(19) United States
(12) Patent Application Publication
(10) Pub. No.: US 2005/0274097 A1
(43) Pub. Date: Dec. 15, 2005

(54) Diesel particulate filter with filleted corners

(76) Inventors: Douglas Munroe Beall, Painted Post, NY (US); Weiguo Miao, Corning, NY (US)

Correspondence Address: CORNING INCORPORATED, SP-TI-3-1, CORNING, NY, 14831, US

(21) Appl. No.: 11/152,122

(22) Filed: Jun. 13, 2005

Related U.S. Application Data
(60) Provisional application No. 60/579,444, filed on Jun. 14, 2004.

(51) Int. Cl. B01D 46/00

(52) U.S. Cl. 55/523

(57) ABSTRACT

A wall-flow filter having a honeycomb body being composed of a plurality of end-plugged cell channels defined by an array of interconnecting and intersecting porous walls, the cell channels extending between end faces of the honeycomb body, the cell channels having fillets at each corner. An extrusion die for making the honeycomb body is described.

### RELATED APPLICATIONS

This application claims priority to, and the benefit of, U.S. Provisional Application 60/579,444 filed Jun. 14, 2004 entitled “Diesel Particulate Filter With Filleted Corners.”

### BACKGROUND OF INVENTION

The invention relates generally to diesel particulate filters, and in particular to wall-flow diesel particulate filters (DPFs) having high mechanical strength and good thermal durability in combination with low pressure drop.

Diesel traps, the most popular of which is the wall-flow DPF, have been widely used in the removal of carbon soot from diesel exhaust. FIG. 1A shows a conventional honeycomb wall-flow filter 100 having an inlet end 102, an outlet end 104, and an array of interconnecting porous walls 106 extending longitudinally from the inlet end 102 to the outlet end 104. The interconnecting porous walls 106 define a grid of inlet channels 108 and outlet channels 110. At the inlet end 102, the outlet channels 110 are end-plugged with plugging material 112 while inlet channels 108 are not end-plugged. Although not visible from the figure, at the outlet end 104, the inlet channels 108 are end-plugged with plugging material while the outlet channels 110 are not end-plugged. Each inlet channel 108 is bordered on all sides by outlet channels 110 and vice versa. FIG. 1B shows a close-up view of the cell structure used in the honeycomb filter. The porous walls 106 defining the inlet and outlet channels (or cells) 108, 110 are straight, and the inlet and outlet cells 108, 110 have a square cross-section and equal hydraulic diameter.

In operation wall-flow filters work to trap carbon soot on the porous walls of the inlet and outlet channels. Diesel exhaust flows into the honeycomb filter 100 through the unplugged ends of the inlet channels 108 and exits the honeycomb filter through the unplugged ends of the outlet channels 110. Inside the honeycomb filter 100, the diesel exhaust is forced from the inlet channels 108 into the outlet channels 110 through the porous walls 106. As diesel exhaust flows through the honeycomb filter 100, soot and ash particles accumulate on the porous walls 106, decreasing the effective flow area of the inlet channels 108. The decreased effective flow area creates a pressure drop across the honeycomb filter, which leads to a gradual rise in back pressure against the diesel engine. When the pressure drop becomes unacceptable, thermal regeneration is used to remove the soot particles trapped in the honeycomb filter. The ash particles, which include metal oxide impurities, additives from lubrication oils, sulfates and the like, are not combustible and cannot be removed by thermal regeneration. During thermal regeneration, excessive temperature spikes can occur, which can thermally shock, crack, or even melt, the honeycomb filter.

Accordingly, it is desirable that the honeycomb filter have sufficient structural strength and thermal durability to withstand thermal regeneration. It is also desirable to have a low pressure drop across the honeycomb filter. One solution which has been proposed to improve the thermal durability involves making the channel walls thicker. This modification has the advantage of increasing the thermal mass of the structure, however it also leads to an increase in the pressure drop. To overcome a higher pressure drop, the porosity is increased. Any increase in the porosity would produce a corresponding decrease in the mechanical strength, thereby making the honeycomb filter more susceptible to thermal shock and cracking during thermal regeneration.

A need therefore exists for a honeycomb filter which combines high mechanical strength and good thermal durability with low pressure drop. It is also desirable to obtain this type of structure at low cost without the need for complicated manufacturing techniques and equipment.

### SUMMARY OF INVENTION

The present invention relates to a wall-flow filter, such as a diesel particulate filter (DPF) having a honeycomb body of improved configuration that offers improved mechanical strength in combination with low pressure drop. At the same time, the structures of the invention retain substantially good thermal mechanical durability at least equivalent to currently available cordierite DPFs.

Accordingly, there is provided a wall-flow filter comprising a honeycomb body having a plurality of end-plugged cell channels defined by an array of interconnecting and intersecting porous walls. The cell channels extend between the end faces of the honeycomb body. The improved properties of the inventive filter are obtained by forming fillets at the corners of the cell channels.

The invention also relates to an extrusion die assembly for making a honeycomb filter which comprises an inlet face; a discharge face opposite the inlet face; a plurality of feed holes extending from the inlet face into a die body; and, an intersecting array of discharge slots extending into the die body from the discharge face to connect the feed holes at feed hole/slot intersections within the die, the slots being formed by an array of pins; wherein the pins have rounded corners to form fillets in the extruded honeycomb body.

Other features and advantages of the invention will be apparent from the following description and the appended claims.

### BRIEF DESCRIPTION OF DRAWINGS

The invention may be further understood by reference to the following drawings, wherein:

FIG. 1A is a perspective view of a prior-art honeycomb wall-flow filter;

FIG. 1B shows a standard honeycomb cell structure having inlet and outlet cells without fillets;

FIG. 2A is a perspective view of a honeycomb wall-flow filter according to an embodiment of the present invention;

FIG. 2B shows a honeycomb cell structure according having filleted inlet and outlet cells;

FIG. 3 illustrate the pin machining process for making a die capable of extruding honeycombs with filleted cell corners; and,

FIG. 4 illustrates a pin array on a discharge face of a die processed according to FIG. 3.

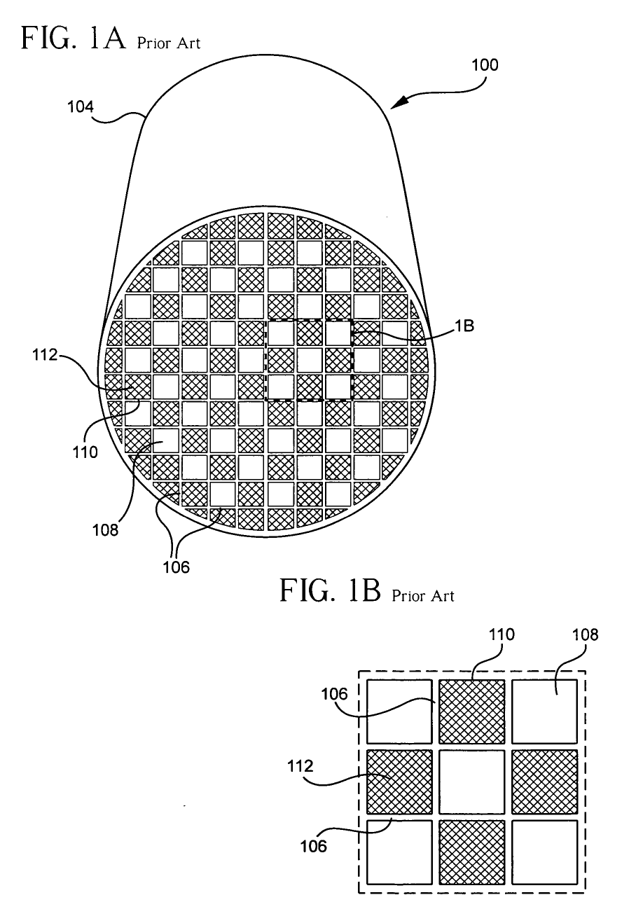

### DETAILED DESCRIPTION OF PREFERRED EMBODIMENTS

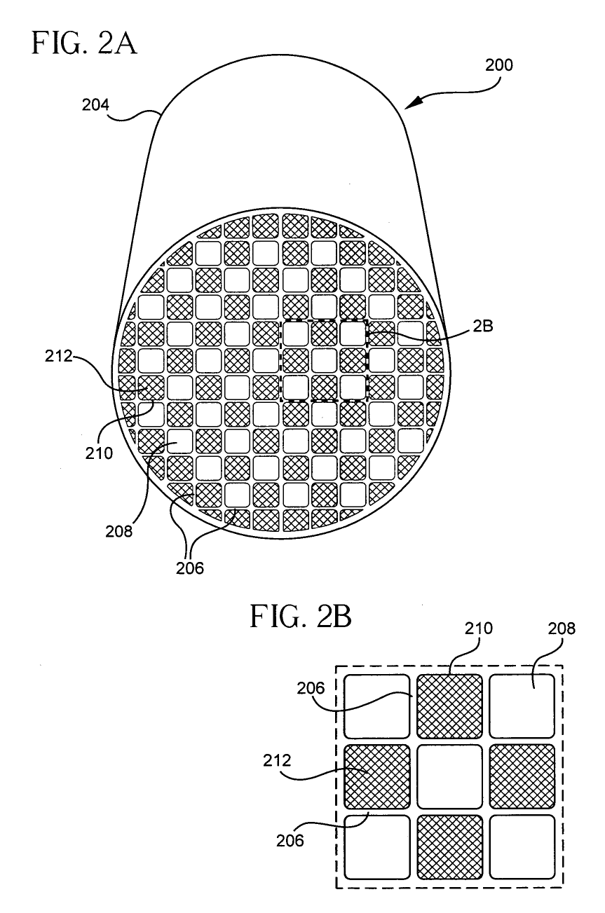

The invention will now be described in detail with reference to a few preferred embodiments, as illustrated in the accompanying drawings. In FIG. 2A honeycomb filter 200 has a columnar body 202 whose cross-sectional shape is defined by a skin (or peripheral wall) 204. The profile of the skin 204 is typically circular or elliptical, but the invention is not limited to any particular skin profile. The columnar body 202 has an array of interconnecting porous walls 206, which intersect with the skin 204. The porous walls 206 define a grid of inlet channels 208 and outlet channels 210 in the columnar body 202. The inlet and outlet channels 208, 210 extend longitudinally along the length of the columnar body 202. Typically, the columnar body 202 is made by extrusion. Typically, the columnar body 202 is made of a ceramic material, such as cordierite or silicon carbide, but could also be made of other extrudable materials, such as glass, glass-ceramics, and metal.

The honeycomb filter 200 has an inlet end 212 for receiving exhaust gas flow, and an outlet end 214 through which filtered flow can exit the honeycomb filter. At the inlet end 212, end portions of the outlet channels 210 are plugged with plugging material 216 while the end portions of the inlet channels 208 are not plugged. Typically, the plugging material 216 is made of a ceramic material, such as cordierite or silicon carbide. Although not visible from the figure, at the outlet end 214, end portions of inlet channels 208 are plugged with filler material while the end portions of the outlet channels 210 are not plugged.

Partial cells near the periphery of the skin 204 are typically plugged with plugging material. Inside the honeycomb filter 200, the interconnected porous walls 206 allow flow from the inlet channels 208 into the outlet channels 210. The porosity of the porous walls 206 can be variable, but is typically between 40-55% by volume.

FIG. 2B shows a close-up view of the cell structure of the honeycomb filter 200. Each inlet cell 208 is bordered by outlet cells 210 and vice versa. The inlet and outlet cells 208, 210 are made to have a square geometry. In the illustration, the corners of the inlet and outlet cells 208, 210 include fillets 218. One purpose of the fillets 218 is to increase the mechanical strength and reduce the stress concentration in the resulting filter. However, the addition of fillets act to increase the pressure drop by increasing the thermal mass of the substrate. To counteract this increase in thermal mass, the thickness, t3, of the wall between the inlet and outlet cells is decreased. The reduction in the wall thickness depends on the cell density of the substrate and it is adjusted to maintain a thermal mass that is equal to the thermal mass of similar substrate without fillets. The radius of the fillets is also adjusted such that together with the cell wall thickness there results a desired thermal mass in the substrate.

For example a standard honeycomb substrate with a cell density of 200 cells/in² (about 31 cells/cm²), and a cell wall thickness of 0.482 mm (19 mil) (hereinafter “200/19”), is modified into substrate with fillets having a radius of 0.275 mm (11 mil) and a cell wall thickness of 0.457 mm (18 mil), both structures having similar thermal mass. Theoretical modeling analysis is used to analyze the impact of fillets in these substrates. The analysis shows that mechanical durability is significantly increased as a result of strengthening and stress reduction resulting from both the addition of the fillets and the increase in fillet radius. In contrast, increasing the fillet radius has a negative effect on the thermal integrity of the substrate. However, the overall impact on the combined mechanical and thermal durability for a filleted substrate is calculated to be positive.

Finite element analysis is used to evaluate the fillet impact under isostatic (ISO) pressure conditions as known in the art. In the calculation, 200/19 standard substrate, and 200/18 with 5 mil and 11 mil fillets are considered. The ISO load is 2 MPa. The displacement of skin in the substrates (i.e., the outer layer surrounding the honeycomb structure) is analyzed to determine correlation to strength (i.e., little skin displacement is indicative of high strength). Among the three samples, 200/18 with 11 mil fillet substrate offers the least skin displacement, which indicates that the mechanical strength of the structure is high (even though it has the same open frontal area and thermal mass as the 200/19 substrate). For 200/18 with 5 mil fillet, the lower thermal mass result in higher displacement at the skin-body interface. Therefore, for substrates of equal thermal mass, fillets increase the strength. Thus, the wall-flow filter preferably includes fillets having a radius of 5 mil (0.127 mm) or greater; more preferably a radius of between 7 and 15 mil (between 0.178 and 0.381 mm).

Absent a decrease in cell wall thickness, the addition of fillets increases the thermal mass of the substrate. As a result the open frontal area is reduced and the pressure drop across the substrate increased. To maintain the same thermal mass of a non-filleted substrate, the cell wall thickness is reduced, which in turn is advantageous in decreasing the pressure drop. In pressure drop tests the impacts of fillets was examined in a standard 200/19 substrate, a high thermal mass 200/20 substrate and a filleted 200/18 substrate with 11 mil fillets. The data shows the lowest pressure drop in the fillet substrate over a range of soot loadings.

Honeycomb extrusion dies suitable for the manufacture of the honeycomb filter described above would have pins with rounded corners. Conventional extrusion dies would be suitable in the present invention if modified to round the corners of the pins. One way to achieve this is with electrical discharge machining (EDM). The EDM method employed, referred to as plunge EDM, involves removing material symmetrically from the side surfaces, and corners of pins in a region near the periphery of the die, using a formed electrical discharge electrode.

A suitable electrical discharge electrode for carrying out the plunge EDM method, can be formed from a copper-tungsten alloy blank using traveling wire electrical discharge machining (wire EDM), as known in the art. Since the invention describes modifying only a portion of a die's pins, the electrode need only encompass that area of the die where these portions of the honeycomb would be formed during extrusion. The area so formed, therefore, includes modification of pins in a region adjacent an outer periphery of the die. Specifically, a plurality of pins in rows extending a portion inward from the outer periphery of the die requiring machining by the electrical discharge electrode.

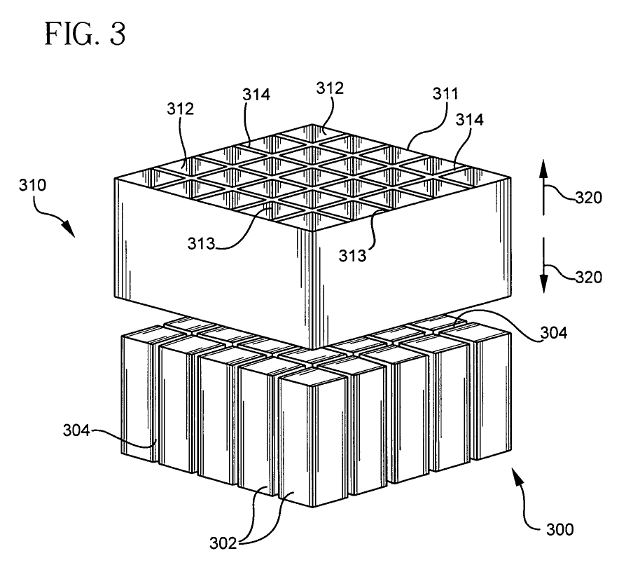

FIG. 3 shows a perspective partial-view of a die 300 and electrode 310 in accordance with the present invention. Die 300 comprises pins 302 and discharge slots 304. Electrode 310 includes openings 312 formed by a network of intersecting webs 314. Webs 314 have rounded corners 313. The shape of electrode 110 is very similar to that of a honeycomb structure, matching the array of pins on the die, so that modification of the pins can be accomplished in groups thereof.

During the plunge EDM process, die 300 is held stationary while electrode 310 is lowered on the array of pins 302. The manner in which electrode 310 moves is indicated by arrow 320. When electrode 310 is lowered into the array of pins 302, the webs 314 being thicker than pre-existing slots 304, remove material symmetrically not only from all side surfaces of pins 302, but also from the corners of pins 302. The rounded corners 313 of webs 314 radius the corners of pins 302 to create fillets in the extruded honeycomb.

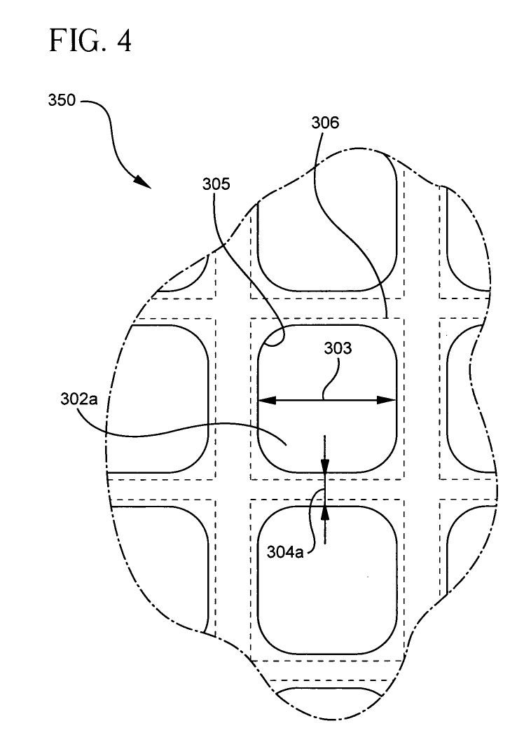

To modify pins 302, electrode 310 is used to remove material symmetrically from the sides of the pins thereof. FIG. 4 shows a plurality of pins 302a which have been machined according to the plunge EDM method of the present invention. The original shape and size of the pins are shown in phantom at 306. The modified pins have a smaller diameter 303, and rounded corners 305, which result in narrower pins and wider discharge slots as shown at reference numeral 304a. The diameter of the pins and the radius of the pin corners depends on the dimensions desired in the final honeycomb structure.

The pin machining process employed does not alter the inlet or feedhole section of the die in any way, nor is there any change to the inlet section of the die required. The geometry of the extruded honeycomb body produced from a machined die of this design has fillets at wall junctions.

The die comprises a feed or inlet section, and a plurality of feedholes for the input of extrudable material to the die, and a discharge section connecting with the feed section for reforming and discharging the extrudable material from a discharge face of the die. As discharged, the material is reformed into a honeycomb shape comprising a plurality of open-ended cells bounded by interconnecting interior walls extending from one end of the structure to another in the direction of extrusion.

The discharge opening in the discharge face of the die may be configured to form any of a variety of shapes for the interconnecting honeycomb wall structure. Currently, the discharge openings used for the extrusion of commercial ceramic honeycombs for treating automotive exhaust gases are formed by a crisscrossing array of long straight discharge slots of equal spacing. These long slots intersect to form a network of shorter slot segments for the forming of straight wall for square- or triangular-celled honeycombs.

Extrudable material first moves from each feedhole through a transition zone into the base of the slot array, where it flows laterally to join with material from adjacent feedholes. Thereafter, the knitted material is again directed forwardly in the direction of feedhole flow toward the discharge opening formed by the slots, being discharged therefrom in the form of an array of interconnecting interior wall portions forming the cell walls of the honeycomb.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A wall-flow filter comprising a honeycomb body having a plurality of end-plugged inlet and outlet cell channels defined by an array of interconnecting and intersecting porous walls, the inlet and outlet cell channels extending between end faces of the honeycomb body, wherein fillets are formed at corners of at least some of both the inlet and outlet cell channels.

2. The wall-flow filter of claim 2 wherein the cell channels are end-plugged in a checkerboard pattern.

3. The wall-flow filter of claim 2 wherein the honeycomb body is composed of a ceramic material.

4. The wall-flow filter of claim 3 wherein the honeycomb body is composed of cordierite.

5. The wall-flow filter of claim 3 wherein the honeycomb body is composed of silicon carbide.

6. The wall-flow filter of claim 1 wherein the fillets are included in substantially all of the inlet and outlet channels.

7. The wall-flow filter of claim 1 wherein the fillets include a radius of 5 mil or greater.

8. The wall-flow filter of claim 1 wherein the fillets include a radius of between 7 and 15 mil.

9. The wall-flow filter of claim 1 wherein the inlet and outlet channels include a square shape in cross section.

10. An extrusion die for fabricating a honeycomb body, the die comprising:
an inlet face;
a discharge face opposite the inlet face;
a plurality of feed holes extending from the inlet face into a die body;
an intersecting array of discharge slots extending into the die body from the discharge face to connect the feed holes at feed hole/slot intersections within the die, the slots being formed by an array of pins;
wherein the pins have rounded corners to form fillets in the extruded honeycomb body.
